(19) United States
(12) Patent Application Publication
(10) Pub. No.: US 2017/0322085 A1
(43) Pub. Date: Nov. 9, 2017

(54) Optical measurement method and system

(71) Applicant: Spectral Engines Oy, Helsinki (FI)

(72) Inventors: Jarkko Antila, Helsinki (FI); Uula Kantojärvi, Helsinki (FI); Jussi Mäkynen, Helsinki (FI)

(21) Appl. No.: 15/524,630

(22) PCT Filed: Nov. 4, 2015
(86) PCT No.: PCT/FI2015/050761

§ 371 Date: May 5, 2017

(30) Foreign Application Priority Data
Nov. 6, 2014 (FI) 20145970

(51) Int. Cl. G01J 3/45; G01J 3/26; G01J 3/02

(52) U.S. Cl. CPC G01J 3/45; G01J 3/0286; G01J 3/26

(57) ABSTRACT

The present invention concerns a method for an optical measurement method including the following steps: illuminating an object by light, receiving light from the illuminated object to a tunable Fabry-Perot interferometer, changing mirror gap of the Fabry-Perot interferometer, and detecting the signal passed through the mirror gap of the Fabry-Perot interferometer at different gap lengths. In accordance with the invention the detection is performed at different lengths of times at different gap lengths.

### TECHNICAL FIELD OF THE INVENTION

The present invention relates to an optical measurement method and system. In particular, the present invention relates to a spectrometer for optical measurement including a Fabry-Perot interferometer. The present invention further relates to a method for analyzing the spectrum of an object.

### BACKGROUND OF THE INVENTION

Optical measurement systems are used for analyzing properties or material contents of a target, for instance. The spectrum of an object, for example a gas or gas mixture, can be measured by using spectrometer comprising a Fabry-Perot interferometer.

A Fabry-Perot interferometer is based on two mirrors, i.e. an input mirror and an output mirror arranged facing the input mirror via a gap. In this document a “mirror” is a structure where there is a layer or a set of layers which reflects light. The pass band wavelength can be controlled by adjusting the distance between the mirrors, i.e. the width of the gap. As changes of temperature of the environment typically affect the temperature of the interferometer, temperature drift will occur in the wavelength response of the interferometer.

Document U.S. Pat. No. 5,818,586 for example describes that a miniaturized spectrometer for gas concentration measurement includes a radiation source for admitting electromagnetic radiation onto the gas to be measured, a detector for detecting the radiation transmitted through or emitted from the gas, an electrically tunable Fabry-Perot interferometer placed in the path of the radiation prior to the detector, control electronics circuitry for controlling the radiation source, the interferometer and the detector. The radiation source, the detector, the interferometer and the control electronics are integrated in a miniaturized fashion onto a common, planar substrate and the radiation source is an electrically modulatable micromechanically manufactured thermal radiation emitter.

Document US 2013/0329232 A1 further discloses controllable Fabry-Perot interferometers which are produced with micromechanical (MEMS) technology. According to the invention the interferometer arrangement has both an electrically tuneable interferometer and a reference interferometer on the same substrate. The temperature drift is measured with the reference interferometer and this information is used for compensating the measurement with the tuneable interferometer. The measurement accuracy and stability can thus be improved and requirements for packaging are lighter.

### SUMMARY OF THE INVENTION

An object of certain embodiments of the present invention is to provide an optical measurement method.

In accordance with one embodiment of the invention an optical measurement method is performed, comprising steps for
illuminating an object (OBJ1) by light,
receiving light (LBJ1) from the illuminated object (OBJ1) to a tunable Fabry-Perot interferometer (100),
changing mirror gap (d_{FP}) of the Fabry-Perot interferometer (100), and
detecting the signal (LB3) passed through the mirror gap (d_{FP}) of the Fabry-Perot interferometer at different gap lengths (d_{FP}), and
performing the detection at different lengths of times at different gap lengths (d_{FP}).

In accordance with another embodiment of the invention with a Fabry-Perot interferometer having a memory and advantageously a tunable amplifier the following method is performed:

Sending at the beginning of the measurement at least two, preferably three initial control values to the controller controlling the spectrometer:

wavelengths corresponding the gap length of the Fabry-Perot interferometer,
measurement times for each wavelength corresponding the gap length of the Fabry-Perot interferometer,
and optionally gain values for each wavelength corresponding the gap length of the Fabry-Perot interferometer.

In the actual measurement the control unit of the sensor measures selected wavelengths one by one with predefined measurement time and gain and sends information for the next measurement gain during the change of the wavelength (typically 1 ms).

With some embodiments of the invention described above a spectral peak of a disturbing material (methane, water) may be eliminated by low gain and short measurement time during the same scanning while the desired characterizing spectrum value of the desired object may be measured for a longer period of time and with higher gain.

With help of some embodiments of the invention the effective dynamical measurement range will be increased essentially.

In some embodiments of the invention the measurement device may be pre-programmed such that it automatically finds optimal gain and measurement times for each wavelength in the beginning of the measurement and uses them after the pre-programming. This Pre-programming is based on the principle of the invention defined in the claims of this application.

An object of certain embodiments of the present invention is to provide an optical measurement system. In particular, an object of certain embodiments is to provide an optical measurement system including a Fabry-Perot interferometer. Another object of certain embodiments of the present invention is to provide a method for analyzing the spectrum of an object. It is also an object of certain embodiments of the present invention to provide a computer readable medium having stored thereon a set of computer implementable instructions.

These and other objects are achieved by embodiments of the present invention, as hereinafter described and claimed. According to an aspect of the invention, there is provided an optical measurement system comprising:
an electrically tunable Peltier element,
a detector for detecting radiation from a radiation source in a measurement area, the detector being in thermal connection with the Peltier element,
an electrically tunable Fabry-Perot interferometer placed in the path of the radiation prior to the detector, the Fabry-Perot interferometer being in thermal connection with the Peltier element, and
control electronics circuitry configured to control the Peltier element, the interferometer, and the detector.

According to an embodiment, the Peltier element is configured to control a temperature of the interferometer. According to an embodiment, the Peltier element is further configured to control the temperature of the interferometer such that the temperature remains essentially constant. According to another embodiment, the Peltier element is configured to control a temperature of the detector.

In an embodiment, the Peltier element, the detector, and the interferometer are arranged in a cavity located in a housing. In another embodiment, the Peltier element is configured to control a temperature in the cavity. According to an embodiment, the Peltier element is further configured to control the temperature in the cavity such that the temperature remains essentially constant. The Peltier element is attached to a frame which is removably connected to the housing. The housing comprises cooling fins in order to increase the surface area of the housing for optimum heat transfer.

In an embodiment, the system includes at least one circuit board.

In another embodiment, the system comprises one or more than one thermistor.

According to another aspect, the object of the embodiments of the invention can be also achieved by a method for analyzing the spectrum of an object, the method comprising:
placing an electrically tunable Fabry-Perot interferometer in the path of a radiation emitted by a radiation source in a measurement area,
detecting the radiation by means of a detector,
controlling an electrically tunable Peltier element which is in thermal connection with the detector and/or interferometer.

According to an embodiment, the effect of a change in temperature of an environment on mechanical dimensions of the interferometer is essentially compensated by means of the Peltier element.

According to another embodiment, the Peltier element is controlled such that a temperature of the detector or the interferometer remains essentially constant.

In an embodiment, the system comprises a filter configured such that a bandwidth of wavelengths can pass the filter. In another embodiment, the bandwidth of wavelengths is a main bandwidth of wavelengths of the Fabry-Perot interferometer. Typically, the bandwidth of wavelengths is in the wavelength range between λ=1 [μm] and λ=2 [μm], λ=1 [μm] and λ=5 [μm], or λ=1 [μm] and λ=10 [μm].

Additionally, according to another aspect, the object of the embodiments of the invention can be also achieved by a computer readable medium having stored thereon a set of computer implementable instructions capable of causing a processor, in connection with the optical measurement system according to any one of claims 1 to 14, to analyze properties or material contents of a radiation source in a measurement area.

Considerable advantages are obtained by means of the embodiments of the present invention. It is possible to achieve high temperature stability since the effect of changes in temperature of the environment on the dimensions of the Fabry-Perot interferometer can be compensated to large extent by means of the Peltier element.

Suprisingly, the measurement by the detector, which is located between the Peltier element and the Fabry-Perot interferometer, is not affected during controlling of the temperature of the interferometer.

### BRIEF DESCRIPTION OF THE DRAWINGS

For a more complete understanding of particular embodiments of the present invention and their advantages, reference is now made to the following descriptions, taken in conjunction with the accompanying drawings. In the drawings:

FIG. 1 illustrates a schematic view of a frame of an optical measurement system according to a first embodiment of the present invention,

FIG. 2 illustrates a schematic perspective view of a portion of a frame of an optical measurement system according to a second embodiment of the present invention,

FIG. 3 illustrates a schematic perspective view of a second transversal element of a frame of an optical measurement system according to a third embodiment of the present invention,

FIG. 4 illustrates a schematic perspective view of a plug to be inserted into a frame of an optical measurement system according to a fourth embodiment of the present invention,

FIG. 5 illustrates a schematic side view of a structure including a Fabry-Perot interferometer, detector, and Peltier element to be inserted into a frame of an optical measurement system according to a fifth embodiment of the present invention,

FIG. 6 illustrates a schematic top view of a portion of a housing of an optical measurement system according to a sixth embodiment of the present invention,

FIG. 7 illustrates a schematic perspective view of a portion of a housing of an optical measurement system according to a seventh embodiment of the present invention,

FIG. 8 illustrates a schematic front view of a portion of an optical measurement system according to an eighth embodiment of the present invention,

FIG. 9 illustrates a schematic front view of an optical measurement system according to a ninth embodiment of the present invention,

FIG. 10 illustrates a schematic perspective view of an optical measurement system according to a tenth embodiment of the present invention,

FIG. 11 illustrates a schematic view of an optical measurement system according to an eleventh embodiment of the present invention, and

FIG. 12 illustrates schematic a flow chart of a method for analyzing the spectrum of an object according to a twelfth embodiment of the present invention.

FIG. 13 illustrates one spectrometer in accordance with the invention.

FIG. 14A shows graphically prior art measurement results.

FIG. 14B shows graphically measurement results in accordance with the invention.

### DETAILED DESCRIPTION OF EMBODIMENTS OF THE INVENTION

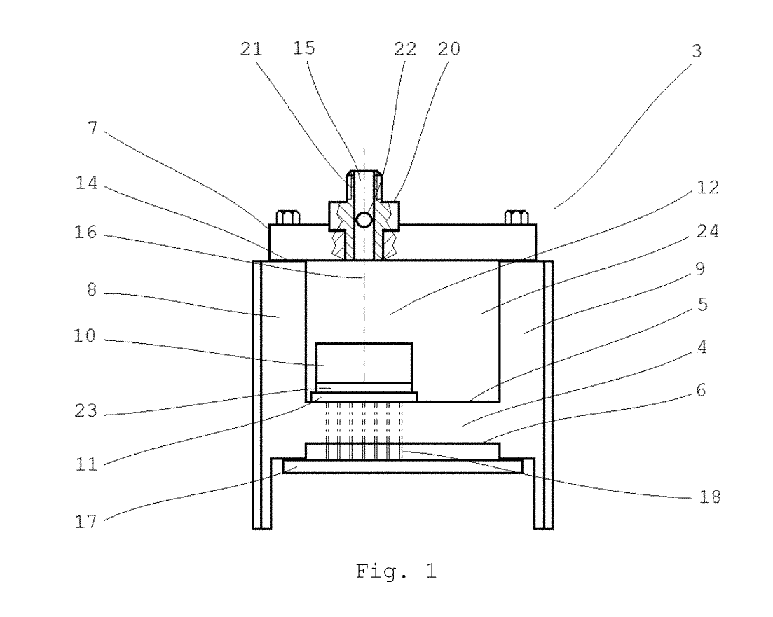

In FIG. 1 a schematic view of a frame 3 of an optical measurement system 1 according to a first embodiment of the present invention is illustrated. The frame 3 includes a first longitudinal element 8 and a second longitudinal element 9 which is separated from the first longitudinal element 8 by a first transversal element 4. On a first side 5 of the first transversal element 4 an electrically tunable Peltier element 11 is fixedly attached. Electrical wires 18 are guided from the Peltier element 11 through the first transversal element 4 to a circuit board 17 which is located on the second side 6 of the first transversal element 4. By means of the Peltier element 11 it is possible to transfer heat from one side of the first transversal 4 element to the other, with consumption of electrical energy, depending on the direction of the current. The Peltier element 11 can be used as a temperature controller that either heats or cools.

A detector 23 for detecting radiation from a radiation source 24 in a measurement area 25 is fixedly attached to the Peltier element 11. Additionally, an electrically tunable Fabry-Perot interferometer 10 is placed in the path of the radiation prior to the detector 23.

Further, a second transversal element 7 is attached to the first and second longitudinal elements 8, 9 of the frame 3 by means of screws and/or adhesive 14. A cover plate 24 is additionally attached to the first and second longitudinal elements 8, 9 and the first transversal element 4. The first and second longitudinal elements 8, 9, the first transversal element 4 and the cover plate 24 may be, for example, milled from a solid piece of metal.

The first and second longitudinal elements 8, 9, the first and second transversal elements 4, 7, and the cover plate 24 form a frame 3 having a cavity 12 which is open to one side. The frame 3 is configured to be inserted into a housing 2 of the measurement system 1, which housing 2 is not shown in FIG. 1. A plug 20 comprising a channel 15 is inserted into the second transversal element 7 in order to provide a channel 15 for radiation from outside the cavity 3 to inside the cavity 3. In other words, a predetermined radiation path 16 is created. In the channel 15 a spherical lens 22 is arranged.

The Peltier element 11, the detector 23, and the interferometer 10 are arranged in the cavity 3 of the housing 2. According to the embodiments, the Peltier element 11 is configured to control a temperature of the interferometer 10. According to certain embodiments, the Peltier element 11 is configured to control a temperature of the detector 23. According to yet other certain embodiments, the Peltier element 11 is configured to control a temperature in the cavity 3. In this case, the Peltier 11 element is, for example, configured to control the temperature in the cavity 3 such that the temperature remains essentially constant.

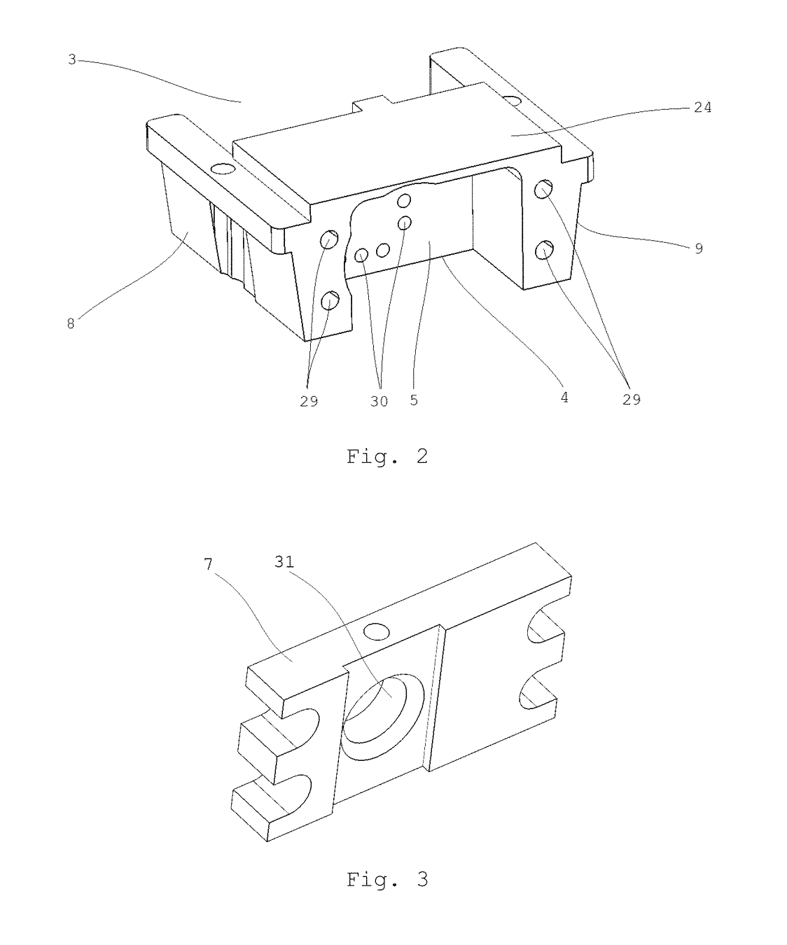

In FIG. 2 illustrates a schematic perspective view of a portion of a frame 3 of an optical measurement system 1 according to a second embodiment of the present invention is illustrated. A second transversal element 7 attached to the first and second longitudinal element 8, 9 is not shown in the figure. The second transversal element 7 may be, for example, attached to the first and second element 8, 9 by means of an adhesive. According to certain embodiments, it is also possible to attach the second transversal element 7 to the first and second longitudinal element 8, 9 by screws in borings 29. Attachment of the second transversal element to the first and second longitudinal element 8, 9 results in forming a cavity 12. The portion of the frame 3 further includes openings 30 through the first transversal element 4 for guiding electrical wiring 18 of the Fabry-Perot interferometer 10, detector 23, and Peltier element 11 from the first side 5 of the first transversal element 4 to the second side 6 of the first transversal element 4.

In FIG. 3 a schematic perspective view of a second transversal element 7 of a frame 3 of an optical measurement system 1 according to a third embodiment of the present invention is illustrated. The second transversal element 7 includes an opening 31 for insertion of a plug 20. The second transversal element 7 is configured to be attached to the first and second longitudinal element 8, 9 by means of adhesive and screws.

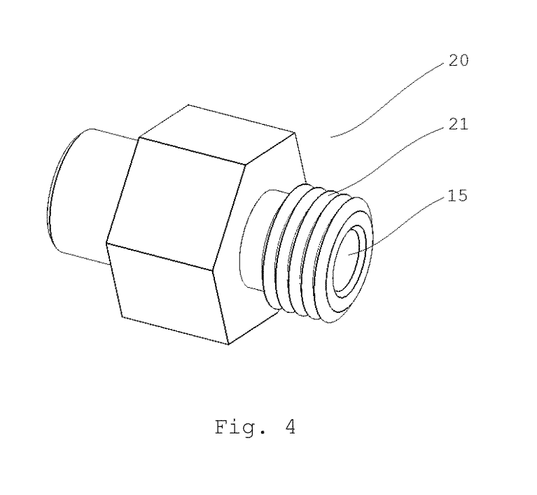

In FIG. 4 a schematic perspective view of a plug 20 to be inserted into a frame 3 of an optical measurement system 1 according to a fourth embodiment of the present invention is illustrated. The plug 20 comprises a channel 15 to be inserted into the second transversal element 7. The plug 20 provides a channel 15 for radiation from outside the cavity 3 to inside the cavity 3. In the channel 15 a lens 22 is arranged. The plug 20 further comprises a thread 21 for attachment of an optical fiber which is to be directed to a radiant source 25 in a measurement area 26.

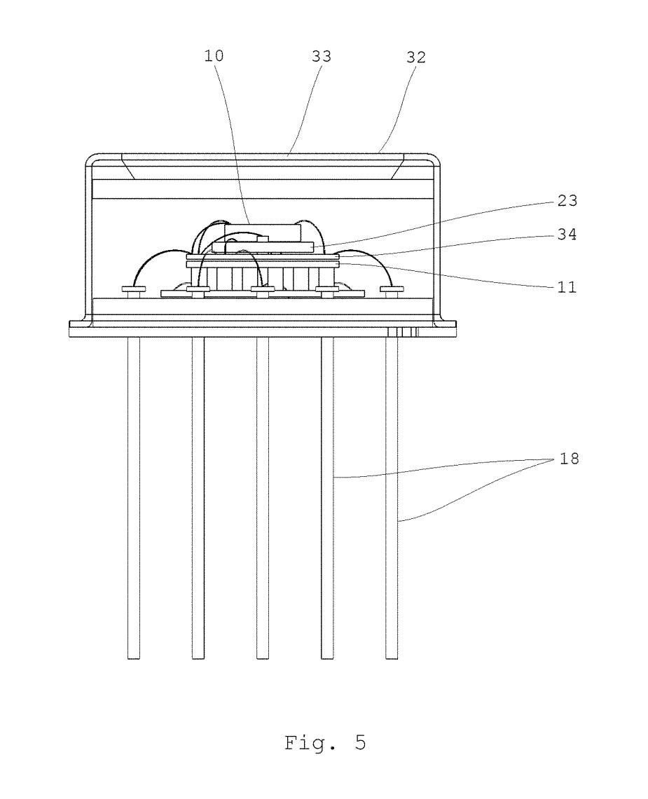

In FIG. 5 a schematic side view of a structure including a Fabry-Perot interferometer 10, a detector 23, and a Peltier element 11 to be inserted into a frame 3 of an optical measurement system 1 according to a fifth embodiment of the present invention is illustrated. Radiation can enter the structure shown through an aperture 32 in which a filter 33 is arranged. The filter 33 is configured such that a certain bandwidth of wavelengths λ can pass the filter. Typically the bandwidth of wavelengths λ is the main bandwidth of the Fabry-Perot interferometer 10. The wavelength range may be, for example, between λ=1 [μm] and λ=2 [μm]. According to certain other embodiments, the wavelength range may be, for example, between λ=1 [μm] and λ=5 [μm], or λ=1 [μm] and λ=10 [μm]. Subsequently the radiation passes the Fabry-Perot interferometer 10 and is then detected by means of the detector 23. The detector 23 may comprise a spacer in order to arrange the detector 23 at a specific distance from the Fabry-Perot interferometer 10. Typically, the detector 23 is configured to detect the filtered wavelengths. According to certain embodiments, the detector 23 is configured to detect at least the bandwidth of wavelengths of the Fabry-Perot interferometer 10. Further, a submount 34 is arranged between the detector 23 and the Peltier element 11. The submount 34 may be, for example a ceramic submount. The Peltier element is configured to control the temperature T₂ of the interferometer 10. According to a certain embodiment, the Peltier element is controlled such that the temperature T₂ of the interferometer 10 remains essentially constant. In this case, the temperature T₂ of the interferometer 10 may be, for example, T₂=20 [° C.], T₂=22 [° C.], T₂=24 [° C.], or any other predetermined temperature. In some embodiments the temperature of the interferometer is kept at 40 [° C.]±0.05 [° C.]. Additionally, the Fabry-Perot interferometer 10, the detector 23, and the Peltier element 11 are connected to electric wires 18.

In FIG. 6 a schematic top view of a portion of a housing 2 of an optical measurement system 1 according to a sixth embodiment of the present invention is illustrated. The housing 2 comprises cooling fins 19 in order to increase the surface area of the housing 2 for optimum heat transfer. The cooling fins 19 extend from the housing 2 to increase the rate of heat transfer to or from the environment. The cooling fins 19 can be considered as an economical solution to heat transfer problems arising in the optical measurement system 1. In addition to the Peltier element 11 attached to the frame 3, which is not shown in FIG. 6, it is possible by means of the cooling fins 19 to reduce the dimensions of the optical measurement system 1 and to provide a simple and compact structure. The housing 2 also comprises a cover in order to create a closed cavity inside the housing, which cover is also not shown in FIG. 6.

According to certain embodiments, a main circuit board 35 is attached to the housing 2. The main circuit board 35 is connected to the circuit board 17 attached to the frame 3 by electrical wires. The main circuit board 35, the circuit board 17, and the electrical wires 18 connected to the Peltier element 11, the detector 23 as well as the Fabry-Perot interferometer 10 form a control electronics circuitry for controlling the Peltier element 11, the interferometer 10, and the detector 23.

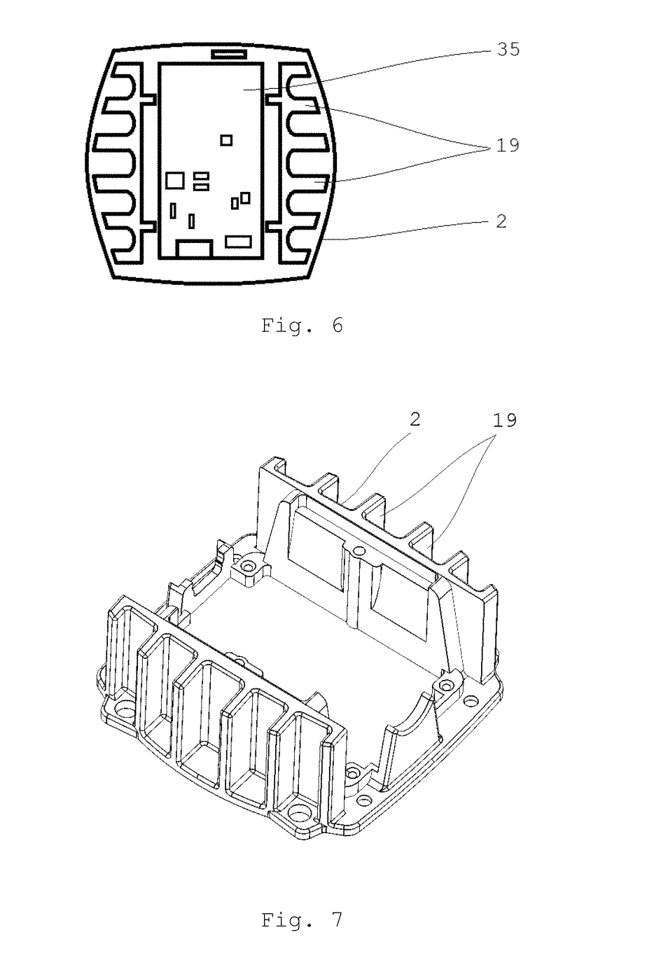

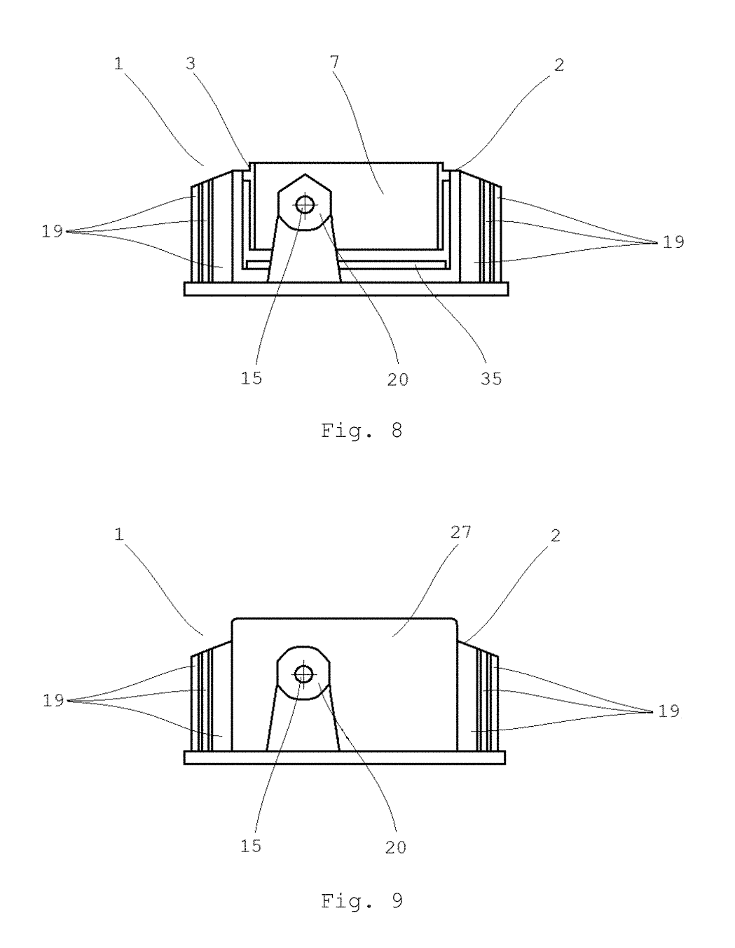

In FIG. 7 a schematic perspective view of a portion of a housing 2 of an optical measurement system 1 according to a seventh embodiment of the present invention is illustrated. The housing 2 is configured such that a frame 3 is to be inserted into the housing 2. According to certain embodiments, the housing 2 is also configured such that a main circuit board 35 is to be attached to the housing 2.

In FIG. 8 a schematic front view of an optical measurement system 1 according to an eighth embodiment of the present invention is illustrated. The frame 3 is inserted into the housing 2. A gap is arranged between the main circuit board 35 and the frame 3 in order to avoid damaging the main circuit board due to physical contact with the frame 3 or due to heat. During operation of the optical measurement system 1 the housing is closed by an additional cover of the housing 2, which cover is not shown in FIG. 8. A change in temperature T₁ of the environment surrounding the housing 2 on the dimensions of the interferometer 10 can be in particular compensated by means of the Peltier element 11 arranged in the cavity 12. Optimum heat transfer between the cavity 12 and the environment can be achieved by the cooling fins 19.

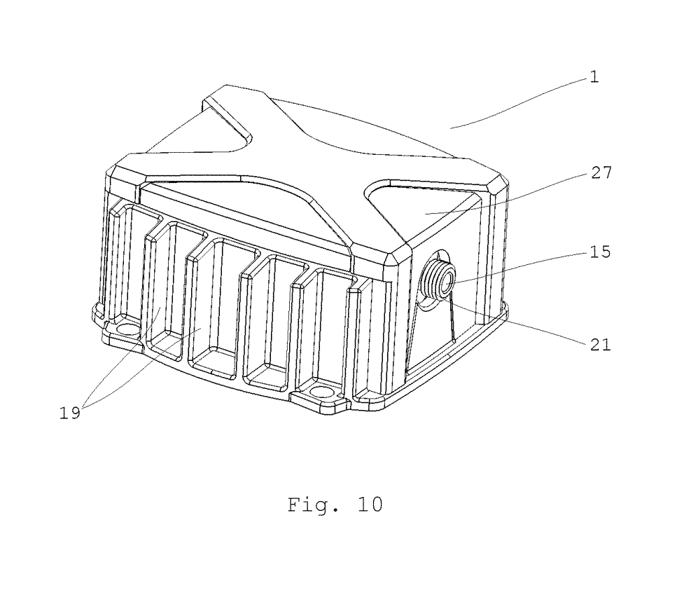

In FIG. 9 a schematic front view of an optical measurement system 1 according to a ninth embodiment of the present invention is illustrated. The housing 2 is closed by means of the cover 27, thus creating a cavity inside the housing 2. The temperature T₂ of the interferometer can be controlled with the Peltier element 11 and the cooling fins 19 depending on the temperature of the environment T₁.

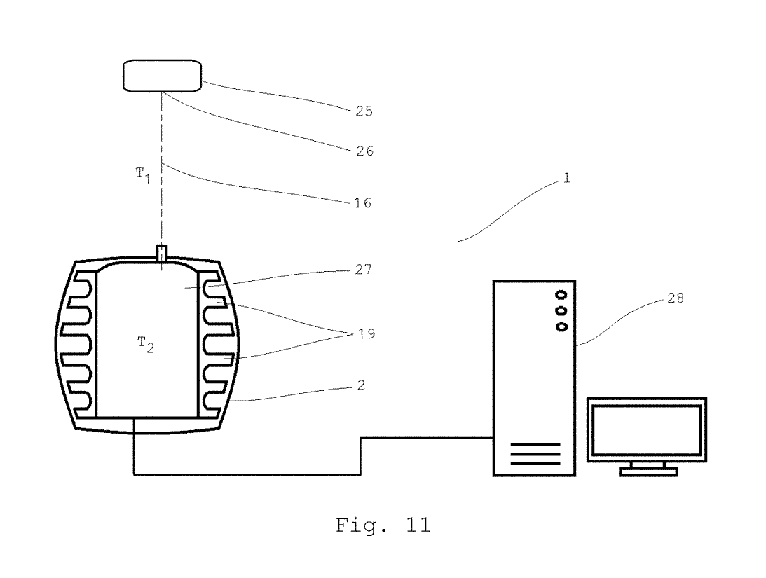

In FIG. 10 a schematic perspective view of an optical measurement system 1 according to a tenth embodiment of the present invention is illustrated.

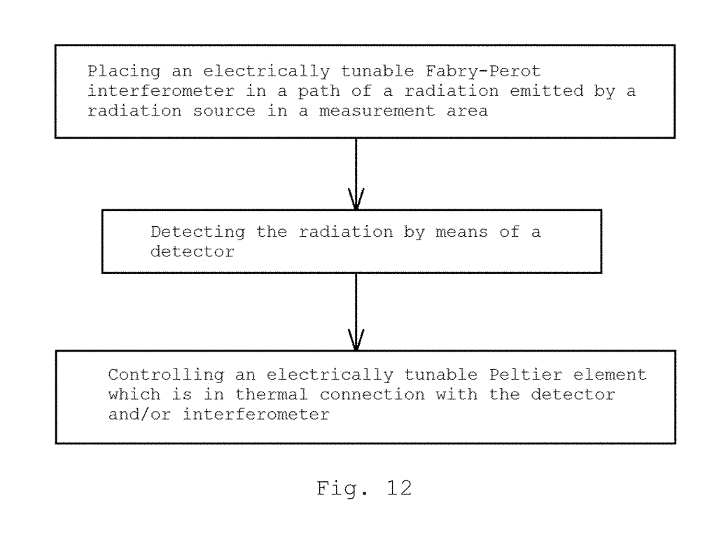

In FIG. 11 a schematic view of an optical measurement system according to an eleventh embodiment of the present invention is illustrated. The optical measurement system 1 is used for analyzing properties or material contents of a radiation source 25 in an environment. The temperature T₁ of the environment may be, for example, T₁=28 [° C.] and the temperature T₂ of the interferometer 10 may be, for example, T₂=22 [° C.], i.e. the temperature difference is ΔT=T₁−T₂=6 [° C.]. Due to the Peltier element 11 and the cooling fins 19 the temperature T₁ of the environment does not affect the temperature T₂ of the interferometer 10, thus providing exact measurement results as the dimensions of the mirrors of the interferometer 10 do not change. Heat is transferred from inside the cavity 12 where the interferometer 10 is located to outside the cavity 12. The optical measurement system 1 further includes a computerized device 28, such as a personal computer or a mobile computing device, which is connected to the main circuit board 18. The computing device 28 includes a computer readable medium having stored thereon a set of computer implementable instructions capable of causing a processor, in connection with the optical measurement system 1, to analyze properties or material contents of the radiation source 25 in the measurement area 26.

In FIG. 12 a schematic flow chart of a method for analyzing the spectrum of an object according to a twelfth embodiment of the present invention is illustrated. Firstly, an electrically tunable Fabry-Perot interferometer is placed in a path of a radiation emitted by a radiation source in a measurement area. Secondly, the radiation is detected by means of a detector. Subsequently, an electrically tunable Peltier element is controlled which is in thermal connection with the detector and/or interferometer.

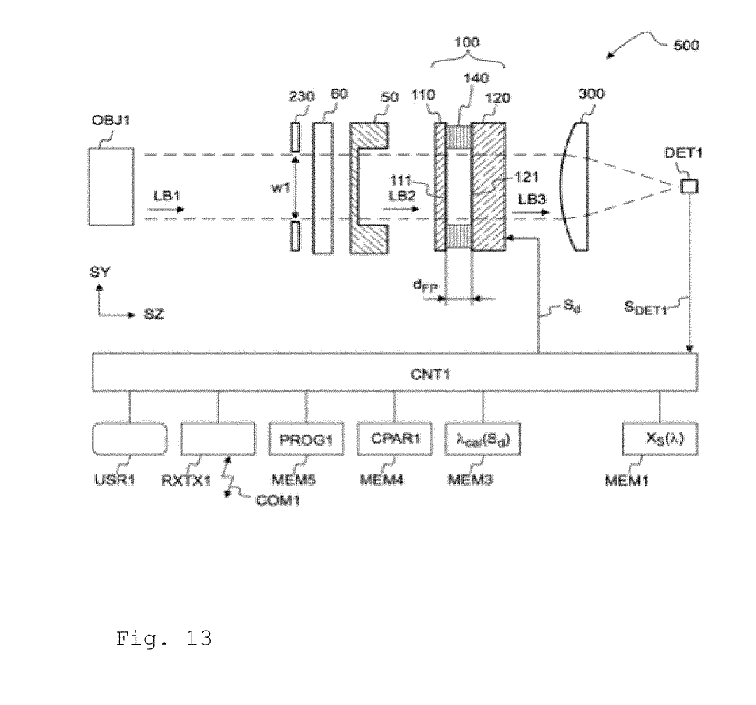

Referring to FIG. 13, a spectrometer 500 may comprise a Fabry-Perot interferometer 100 and a detector DET1. An object OBJ1 may reflect, emit and/or transmit light LB1. The light LB1 may be coupled into the spectrometer 500 in order to monitor the spectrum of the light LB1.

The Fabry-Perot interferometer 100 comprises a first semi-transparent mirror 110 and a second semi-transparent mirror 120. The distance between the first mirror 110 and the second mirror 120 is equal to a mirror gap d_{FP}. The mirror gap d_{FP} may be adjustable. The first mirror 110 may have a solid-gas interface 111, and the second mirror 121 may have a solid-gas interface 121. The mirror gap d_{FP} may denote the distance between the interfaces 111 and 121. The Fabry-Perot interferometer 100 may provide a transmission peak P_{FP,k}, wherein the spectral position of the transmission peak P_{FP,k} may depend on the mirror gap d_{FP}. The spectral position of the transmission peak P_{FP,k} may be changed by changing the mirror spacing d_{FP}. The transmission peak P_{FP,k} may also be called as the passband of the Fabry-Perot interferometer 100.

The spectrometer 500 may comprise one or more filters 60 to define a detection band Δλ_{PS} of the spectrometer 500. The filter 60 may provide filtered light LB2 by filtering the light LB1 received from the object OBJ1.

The Fabry-Perot interferometer 100 may form transmitted light LB3 by transmitting a portion of the filtered light LB2 to the detector DET1. Transmitted light LB3 obtained from interferometer 100 may be coupled to the detector DET1. The transmitted light LB3 may at least partly impinge on the detector DET1.

An actuator 140 may be arranged to move the first mirror 110 with respect to the second mirror 120. The actuator 140 may be e.g. an electrostatic actuator, or a piezoelectric actuator. The mirrors 110, 120 may be substantially flat and substantially parallel to each other. The semi-transparent mirrors 110, 120 may comprise e.g. a metallic reflective layer and/or a reflective dielectric multilayer. One of the mirrors 110, 120 may be attached to a frame, and the other mirror may be moved by the actuator 140.

The light LB1 may be obtained from an object OBJ1. For example, the light LB1 may be emitted from the object, the light LB1 may be reflected from the object, and/or the light LB1 may be transmitted through the object. The spectrum of the light LB1 may be measured e.g. in order to determine emission spectrum, reflectance spectrum, and/or absorption spectrum of the object OBJ1.

The object OBJ1 may be e.g. a real or virtual object. For example, the object OBJ1 may be a tangible piece of material. The object OBJ1 may be a real object. The object OBJ1 may be e.g. in solid, liquid, or gaseous form. The object OBJ1 may comprise a sample. The object OBJ1 may a combination of a cuvette and a chemical substance contained in the cuvette. The object OBJ1 may be e.g. a plant (e.g. tree or a flower), a combustion flame, or an oil spill floating on water. The object may be e.g. the sun or a star observed through a layer of absorbing gas. The object OBJ1 may be a display screen, which emits or reflects light of an image. The object OBJ1 may be an optical image formed by another optical device. The object OBJ1 may also be called as a target.

The light LB1 may also be provided e.g. directly from a light source, by reflecting light obtained from a light source. The light source may comprise e.g. an incandescent lamp, a blackbody radiator, an infrared light emitting glow-bar, a tungsten halogen lamp, a fluorescent lamp, or a light emitting diode.

The mirror gap d_{FP} of the interferometer 100 may be varied according to the control signal S_{d}. For example, the mirror gap d_{FP} may be adjusted by converting the control signal S_{d} into driving voltage, which is applied to the actuator 140 of the interferometer 100. Alternatively, the mirror gap d_{FP} may be monitored e.g. by a capacitive sensor, which may provide the control signal Sd.

The spectrometer 500 may comprise a control unit CNT1. The control unit 30 may comprise one or more data processors. The control unit CNT1 may be arranged to provide a control signal S_{d} for controlling the mirror spacing d_{FP} of the interferometer 100. For example, the spectrometer 500 may comprise a driving unit, which may be arranged to convert a digital control signal S_{d} into a voltage signal Vab. The voltage signal V_{ab} may be coupled to a piezoelectric actuator or to en electrostatic actuator in order to adjust the mirror gap d_{FP}. The control signal S_{d} may be indicative of the mirror

The light LB1 may also be provided e.g. directly from a light source, by reflecting light obtained from a light source, by transmitting light obtained from a light source. The light source may comprise e.g. an incandescent lamp, a blackbody radiator, an infrared light emitting glow-bar, a tungsten gap d_{FP}. In an embodiment, the control signal S_{d} may be proportional to the voltage signal Vab coupled to the actuator. The driving unit may convert a digital signal S_{d} into an analog signal suitable for driving the actuator.

The control signal S_{d} may also be a sensor signal. The interferometer may comprise e.g. a capacitive sensor for monitoring the mirror gap d_{FP}. The capacitive sensor may be arranged to provide the control signal S_{d} by monitoring the mirror gap d_{FP}. The control signal S_{d} may be used as a feedback signal indicative of the mirror spacing d_{FP}.

The spectrometer 500 may optionally comprise light concentrating optics 300 for concentrating light into the detector DET1. The optics may comprise e.g. one or more lenses and/or one or more reflective surfaces (e.g. a paraboloid reflector). The optics 300 be positioned after the interferometer 100. The optics 300 may be positioned after the interferometer 100 (i.e. between the interferometer 100 and the detector DET1). One or more components of the optics 300 may be positioned before the interferometer 300, and one or more components of the optics 300 may be positioned after the interferometer.

The detector DET1 may arranged to provide a detector signal S_{DET1}. The detector signal S_{DET1} may be indicative of the intensity I₃ of light LB3 impinging on the detector DET1 into a detector signal value S_{DET1}.

The detector DET1 may be sensitive e.g. in the ultraviolet, visible and/or infrared region. The spectrometer 500 may be arranged to measure spectral intensities e.g. in the ultraviolet, visible and/or infrared region. The detector DET1 may be selected according to the detection range of the spectrometer 500. For example, the detector may comprise e.g. a silicon photodiode. The detector may comprise a P-N junction. The detector may be a pyroelectric detector. The detector may be a bolometer. The detector may comprise a thermocouple. The detector may comprise a thermopile. The detector may be an Indium gallium arsenide (InGaAs) photodiode. The detector may be a germanium photodiode. The detector may be a photoconductive lead selenide (PbSe) detector.

The detector DET1 may be arranged to provide a detector signal S_{DET1}. The detector signal S_{DET1} may be indicative of the intensity I₃ of light LB3 impinging on the detector DET1. The detector DET1 may convert the intensity I₃ of light LB3 impinging on the detector DET1 into a detector signal selenide (PbSe) detector. The detector may be a photoconductive Indium antimonide (InSb) detector. The detector may be a photovoltaic Indium arsenide (InAs) detector. The detector may be a photovoltaic Platinum silicide (PtSi) detector. The detector may be an Indium antimonide (InSb) photodiode. The detector may be a photoconductive Mercury cadmium telluride (MCT, HgCdTe) detector. The detector may be a photoconductive Mercury zinc telluride (MZT, HgZnTe) detector. The detector may be a pyroelectric Lithium tantalate (LiTaO3) detector. The detector may be a pyroelectric Triglycine sulfate (TGS and DTGS) detector. The detector DET1 may be an imaging detector or a non-imaging detector. The detector may comprise one or more pixels of a CMOS detector. The detector may comprise one or more pixels of a CCD detector.

The spectrometer 500 may comprise a memory MEM4 for storing intensity 15 calibration data CPAR1. One or more intensity values I1 of the light LB1 may be determined from the detector signals SDET1 by using the intensity calibration data CPAR1. The intensity calibration data CPAR1 may comprise e.g. one or more parameters of a regression function, which allows determining intensity values I1 of the light LB1 from the detector signal values S_{DET1}.

Spectral calibration data may determine a relation between values of the control signal S_{d} and spectral positions λ. A calibration function λ_{cal}(Sd) may determine a relation for obtaining spectral positions from values of the control signal S_{d}. Spectral calibration data may comprise parameters of a function λ_{cal}(Sd), which gives spectral position λ as the function of the control signal S_{d}.

Spectral calibration data S_{d,cal}(λ) may determine a relation for obtaining values of the control signal S_{d} from spectral positions λ. Spectral calibration data may comprise parameters of a function S_{d,cal}(λ) which gives control signal Sd as the function of the spectral position λ.

Each determined intensity value I₁ may be associated with a value of the control signal S_{d}, and the determined intensity value I₁ may be associated with a spectral position λ based on said control signal value S_{d} and spectral calibration data.

Each measured detector signal value S_{DET1} may be associated with a value of the control signal Sd, and the detector signal value S_{DET1} may be associated with a spectral position λ based on the control signal value S_{d} and spectral calibration data.

The spectrometer 500 may comprise a memory MEM3 for storing spectral calibration data. The spectral calibration data λ_{cal}(Sd) may comprise e.g. one or more parameters of a regression function, which allows determining the relationship between control signal values S_{d} and spectral positions λ. The spectrometer 500 may be arranged to determine spectral positions λ from control signal values S_{d} by using the spectral calibration data. The spectrometer 500 may comprise a memory MEM5 for storing a computer program PROG1. The computer program PROG1 may be configured, when executed by one or more data processors (e.g. CNT1), to determine spectral positions from control signal values Sd by using the spectral calibration data.

The spectrometer 500 may be arranged to obtain detector signal values S_{DET1} from the detector DET1, and to determine intensity values I₁ from the detector signal values S_{DET1} by using the intensity calibration data CPAR1. The computer program PROG1 may be configured, when executed by one or more data processors (e.g. CNT1), to obtain detector signal values S_{DET1} from the detector DET1, and to determine intensity values I₁ from the detector signal values S_{DET1} by using the intensity calibration data CPAR1.

The spectrometer 500 may optionally comprise a memory MEM1 for storing 30 spectral data XS(λ). The spectral data X_{S}(λ) may comprise e.g. intensity values I₁ determined as a function I₁(λ) of the spectral position λ. The spectral data X_{S}(λ) may comprise a calibrated measured spectrum I₁(λ). The spectral data X_{S}(λ) may comprise e.g. detector signal values S_{DET1} determined as a function S_{DET1}(λ) of the spectral position λ.

The spectrometer 500 may optionally comprise a user interface USR1 e.g. for displaying information and/or for receiving commands. The user interface USR1 may comprise e.g. a display, a keypad and/or a touch screen.

The spectrometer 500 may optionally comprise a communication unit RXTX1. The communication unit RXTX1 may transmit and/or receive a signal COM1 e.g. in order to receive commands, to receive calibration data, and/or to send spectral data. The communication unit RXTX1 may be capable of wired and/or wireless communication. For example, the communication unit RXTX1 may be capable of communicating with a local wireless network (WLAN), with the Internet and/or with a mobile telephone network.

The spectrometer 500 may be implemented as a single physical unit or as a combination of separate units. In an embodiment, the interferometer 100, and the units CNT1, MEM1, MEM3, MEM4, MEM5, USR1, RXTX1 may be implemented in the same housing. In an embodiment, the spectrometer 500 may be arranged to communicate detector signals S_{DET1} and control signals S_{d} with a remote data processing unit, e.g. with a remote server. Spectral positions λ may be determined from the control signals S_{d} by the remote data processing unit.

The spectrometer 500 may optionally comprise one or more optical cut-off filters 60 to limit the spectral response of the detector DET1. The filters 60 may define the detection band of the spectrometer 500. The filters 60 may be positioned before and/or after the interferometer 100.

The spectrometer 500 may optionally comprise e.g. a lens and/or an aperture 230, which is arranged to limit the divergence of the light LB3 transmitted through the interferometer 100 to the detector DET1, in order to provide a narrow bandwidth Δλ_{FP} of the transmission peak P_{FP,k}. For example, the divergence of the light LB3 may be limited to be e.g. smaller than or equal to 10 degrees. When using light concentrating optics 300, the divergence of light LB3 contributing to the spectral measurement may also be limited by the dimensions of the detector DET1.

SX, SY and SZ denote orthogonal directions. The light LB2 may propagate substantially in the direction SZ. The mirrors 110, 120 of the interferometer may be substantially perpendicular to the direction SZ. The directions SZ and SY are shown in FIG. 13. The direction SX is perpendicular to the plane of drawing of FIG. 13.

The spectrometer of FIG. 13 may comprise a Fabry-Perot etalon 50 for determining and/or verifying the spectral scale of the interferometer. For example, the system of FIG. 1-12 may comprise the spectrometer of FIG. 13.

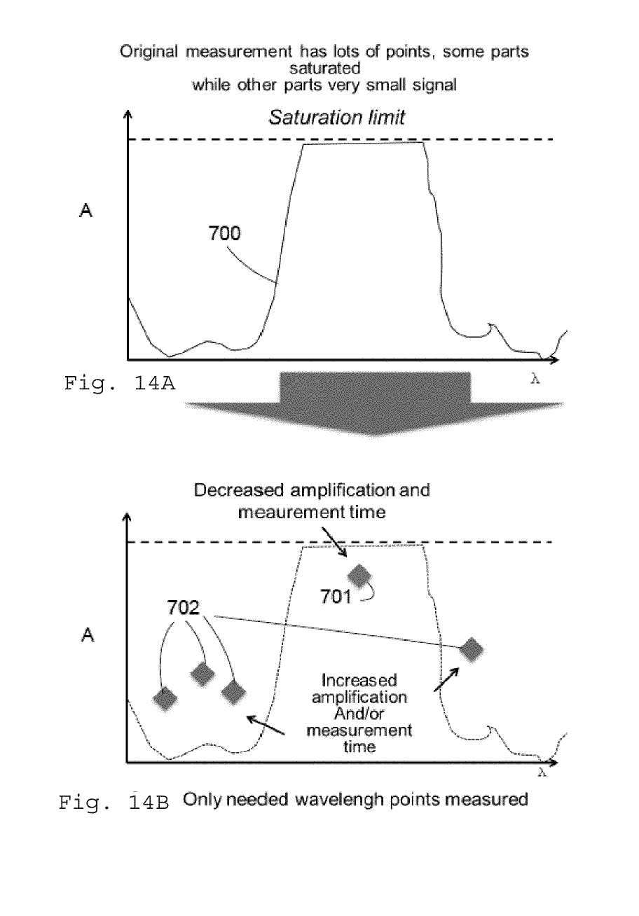

In FIGS. 14a and 14b is presented graphically as a comparison a principle in accordance with the invention where FIG. 14a presents prior art with continuous measurement and continuous measurement curve 700. In FIG. 14b is shown how some measurement points 701 including spectral data at characteristic wavelengths of the measurement object are measured longer (e.g. 1.5-100 times longer) and with higher gain (e.g. with 1.5-20 times higher) than other wavelengths 702 with less interest.

According to a certain embodiment, the effect of a change in temperature of an environment on mechanical dimensions of the interferometer is compensated by means of the Peltier element. According to another certain embodiment, the Peltier element is controlled such that a temperature of the detector and/or the interferometer remains essentially constant.

According to a certain embodiment of the invention applicable in connection with all embodiments described above the spectrometer 500 or Fabry-Perot interferometer 100 may automatically set the parameters e.g. by the following process:
1. The operator determines the desired wavelengths, their weighted importance (e.g. by scale from 1 to 10) and maximum measurement time (e.g. 1-15 seconds)
2. The spectrometer 500 or Fabry-Perot interferometer 100 measures the spectrum at the desired wavelengths with minimum gain
3. The spectrometer 500 or Fabry-Perot interferometer 100 increases the gain at each wavelength so much that the overall signal level is about 90% of the maximum amplitude.
4. The measurement time is increased with the desired weighted importance such that the desired maximum measurement time is reached.
5. After this the measurement information is three vectors:
   I. the spectrum created by the measurement
   II. gain information for each wavelength and
   III. measurement time for each wavelength
   IV. These will be multiplied one by one at each wavelength in order to obtain weighted spectrum with high dynamic range.

Although the present invention has been described in detail for the purpose of illustration, various changes and modifications can be made within the scope of the claims. In addition, it is to be understood that the present disclosure contemplates that, to the extent possible, one or more features of any embodiment may be combined with one or more features of any other embodiment.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

### LIST OF REFERENCE NUMBERS

1 optical measurement system
2 housing
3 frame
4 first transversal element
5 first side of first transversal element
6 second side of first transversal element
7 second transversal element
8 first longitudinal element
9 second longitudinal element
10 Fabry-perot interferometer
11 Peltier element
12 cavity
13 attachment area
14 adhesive
15 channel
16 radiation path
17 circuit board
18 electric wiring
19 cooling fins
20 plug
21 thread
22 lens
23 detector
24 cover plate
25 radiation source
26 measurement area
27 cover
28 computerized device
29 boring for screw
30 opening for electric wires
31 opening for plug
32 aperture
33 filter
34 submount
35 main circuit board
T₁ temperature of environment
T₂ temperature of interferometer
ΔT temperature difference
λ wavelength, spectral position
50 a second Fabry-Perot Etalon
60 cut-off filter
100 Fabry-Perot interferometer
110 mirror of Fabry-Perot interferometer
111 solid-gas interface
120 mirror of Fabry-Perot interferometer
121 solid-gas interface
140 actuator
230 aperture
300 concentrating optics
500 spectrometer
700 prior art measurement curve
701 wavelengths characteristic for the object
702 other wavelengths
DET1 detector
OBJ1 object to be measured
LB1 light received from object OBJ1
LB2 filtered light
LB3 light transmitted through the Fabry-Perot interferometer
DET1 detector
W1 width of the aperture 230
S_{d} control signal
S_{DET1} measured detector signal value
SX orthogonal direction
SY orthogonal direction
SZ orthogonal direction
CNT1 control unit
MEM3 memory
d_{FP} mirror gap of the Fabry-Perot interferometer

1. An optical measurement method comprising the steps of:
illuminating an object by light,
receiving light from the illuminated object to a tunable Fabry-Perot interferometer,
changing mirror gap of the Fabry-Perot interferometer,
detecting the signal passed through the mirror gap of the Fabry-Perot interferometer at different gap lengths, and
performing the detection at different lengths of times at different gap lengths.

2. The method in accordance with claim 1, wherein the gap lengths corresponding the characteristic wavelengths of the object are measured longer than the other gap lengths.

3. The method in accordance with claim 1, wherein the gap lengths corresponding the characteristic wavelengths of the object are measured 1.5-100 times, preferably 5-30 times longer than the other gap lengths.

4. The method in accordance with claim 1, wherein the measurement signal at gap lengths corresponding the characteristic wavelengths of the object are amplified more than the other gap lengths.

5. The method in accordance with claim 1, wherein the measurement signal of the gap lengths corresponding to the characteristic wavelengths of the object are amplified 2-10 times more than the other gap lengths.

6. The method in accordance with claim 1, further comprising the steps of:
sending at the beginning of the measurement at least two, preferably three initial control values to the controller controlling the spectrometer:
i. wavelengths corresponding the gap length of the Fabry-Perot interferometer,
ii. measurement times for each wavelength corresponding the gap length of the Fabry-Perot interferometer, and
iii. optionally gain values for each wavelength corresponding the gap length of the Fabry-Perot interferometer.

7. An optical measurement method comprising the steps of:
receiving from an operator desired wavelengths, their weighted importance and maximum measurement time,
measuring by a spectrometer or a Fabry-Perot interferometer the spectrum at the desired wavelengths with minimum gain,
increasing the gain at each wavelength so much that the overall signal level is about 90% of the maximum amplitude, and
increasing the measurement time with the desired weighted importance such that the desired maximum measurement time is reached.

8. The optical measurement method in accordance with claim 7, further comprising the steps of:
based on the measurement forming vectors for:
V. the spectrum created by the measurement,
VI. gain information for each wavelength, and
VII. measurement time for each wavelength,
multiplying these vectors one by one at each wavelength in order to obtain weighted spectrum with high dynamic range.

9. An optical measurement system comprising means for:
illuminating an object by light,
receiving light from the illuminated object to a tunable Fabry-Perot interferometer,
changing the mirror gap of the Fabry-Perot interferometer,
detecting the signal passed through the mirror gap of the Fabry-Perot interferometer at different gap lengths, and
performing the detection at different lengths of times at different gap lengths.

10. The system in accordance with claim 9, further comprising means for measuring the gap lengths corresponding to the characteristic wavelengths of the object longer than the other gap lengths.

11. The system in accordance with claim 9, further comprising means for measuring the gap lengths corresponding to the characteristic wavelengths of the object 1.5-100 times, preferably 5-30 times longer than the other gap lengths.

12. The system in accordance with claim 9, further comprising means for amlifyining the measurement signal at gap lengths corresponding to the characteristic wavelengths of the object more than the other gap lengths.

13. The system in accordance with claim 9, further comprising means for amplifying the measurement signal at gap lengths corresponding to the characteristic wavelengths of the object 2-10 times more than the other gap lengths.

14. The system in accordance with claim 9, further comprising means for:
sending at the beginning of the measurement at least two, preferably three initial control values to the controller controlling the spectrometer:
i. wavelengths corresponding the gap length of the Fabry-Perot interferometer,
ii. measurement times for each wavelength corresponding the gap length of the Fabry-Perot interferometer, and
iii. optionally gain values for each wavelength corresponding the gap length of the Fabry-Perot interferometer.

15. An optical measurement system comprising means for—:
receiving from an operator desired wavelengths, their weighted importance and maximum measurement time,
measuring by a spectrometer or a Fabry-Perot interferometer the spectrum at the desired wavelengths with minimum gain,
increasing the gain at each wavelength so much that the overall signal level is about 90% of the maximum amplitude, and
increasing the measurement time with the desired weighted importance such that the desired maximum measurement time is reached.

16. The optical measurement system in accordance with claim 15, further comprising:
based on the measurement forming vectors for:
VIII. the spectrum created by the measurement,
IX. gain information for each wavelength, and
X. measurement time for each wavelength,
multiplying these vectors one by one at each wavelength in order to obtain weighted spectrum with high dynamic range.
